(19) United States
(12) Patent Application Publication
(10) Pub. No.: US 2003/0028868 A1
(43) Pub. Date: Feb. 6, 2003

(54) Information processor, method for processing information and computer-readable recording medium recorded with program code for controlling a computer to process information

(75) Inventor: Yuji Kumakura, Nagaoka-shi (JP)

Correspondence Address: STAAS & HALSEY LLP, 700 11TH STREET, NW, SUITE 500, WASHINGTON, DC, 20001, US

(73) Assignee: FUJITSU LIMTED of Kawasaki, Japan

(21) Appl. No.: 09/488,019

(22) Filed: Jan. 20, 2000

(30) Foreign Application Priority Data
Mar. 2, 1999 (JP) 11-054179

(51) Int. Cl. G06F 9/445

(52) U.S. Cl. 717/175; 707/200

(57) ABSTRACT

The present invention provides an information processor that can move an application easily and safely. In the information processor, a control information retrieving part retrieves the control information that is used to execute a program and a destination defining part defines destination address information to move the program. Then, a moving part moves the program in accordance with the destination address information. Also, a control information changing part changes the control information based on the destination address information.

### BACKGROUND OF THE INVENTION

1. Field of the Invention

The present invention generally relates to information processors, methods for processing information and computer-readable recording media recorded with program code for controlling a computer to process information in which installed applications are moved to another directory or another recording medium, and more particularly to an information processor, a method for processing information and a computer-readable recording medium recorded with program code for controlling a computer to process information in which it is possible to copy an installed application including related data from a current directory to another directory or another recording medium and continuously to delete the application including related data in the current directory.

Recently, in the personal computer (hereinafter called a PC) industry, a storage device has been developed and a capacity of the storage device is becoming much larger so that a large-sized operating system and various large-sized applications can be installed in the storage device. With increasing capacities of applications, data belonging to the applications are becoming diversified and also large sized. In this state, actually, the existing storage device does not have enough capacity to manage the applications and data belonging thereto. Usually, many PC users install an additional internal or external storage device to their PCs. In addition, the PC users reinstall the same applications installed in the existing storage device to the new storage device.

In the above state, as a result of moving existing applications to another directory, it is required that the installed applications be uninstalled, the applications be reinstalled, and an OS (Operation System) be restarted a few times. However, these processes are not performed effectively. Especially for inexperienced users, it is not easy to complete these processes without any problems. Therefore, it is desired that a method for installing an application should be simplified.

2. Description of the Related Art

Conventionally, the following processes are required to reinstall an application in another directory or storage device.

First, a conventional installation will be explained with reference to FIG. 1.

FIG. 1 shows an example of a setup window for a conventional installation.

Generally, when a user installs an application, the user chooses a type of installation from a setup window and clicks a button corresponding to the type of installation so as to start to install the application.

In FIG. 1, the user chooses a desired operation from a setup window 200. For instance, when the user installs an application for the first time, the user selects an “INSTALL” button 201 for the initial installation. When the user reinstalls the application including additional functions in the directory in which the application and the additional functions are already installed, the user also selects the “INSTALL” button 201.

When the user adds more functions to currently installed application and functions, the user selects an “ADD FUNCTIONS” button 202.

When the user removes the currently installed functions, the user selects a “REMOVE FUNCTIONS” button 203.

When the user cancels the setup, the user selects a “CANCEL” button 204.

Any operation selected by the above buttons, except for the initial installation, is performed under the directory in the drive indicated at the initial installation.

When the user moves an installed application to another storage area, that is, when the user uninstalls the application and then installs the application to another storage area, the following steps are required:

step 1: if necessary, store all data created by the application.

step 2: execute an uninstallation program to delete the application from the storage area.

step 3: restart an OS.

step 4: open the setup window to click “INSTALL” button 201 in FIG. 1 and indicate a destination to install the application after restarting the OS.

step 5: restart the OS again after the installation is completed.

step 6: if necessary, restore all data stored in the step 1 to a destination directory.

The user follows the above-mentioned steps to complete the move of the application and the data.

However, the above-mentioned conventional manner to move an application has the following disadvantages:

First, as mentioned above, the many steps to move an application take much time.

Second, a user generally changes optional settings of the application to fit the user's requirements after the first installation. For example, font size, spacing between lines, lines per page, and the like may be the optional settings. Thus, the user has to set the optional settings again after the application is moved to another directory. In addition, the user has to restore data that is temporarily stored in another storage area. Thus, it may not be possible for the user to use the application soon after the reinstallation thereof. Actually, an inexperienced user tends to lose important data during the above steps. Therefore, it is preferable to perform the steps by an experienced user.

Third, regardless of the above steps, when a user moves an application, the user is required to properly change information for executing the application, which information is recorded in a file referred to by other applications or the OS. Hence, when the user does not properly change the information in the file, not only the application but also other applications and the OS do not perform properly.

### SUMMARY OF THE INVENTION

It is a general object of the present invention to provide an information processor, a method for processing information and a computer-readable recording medium recorded with program code for controlling a computer to process information in which the above-mentioned problems are eliminated.

A more specific object of the present invention is to provide an information processor, a method for processing information and a computer-readable recording medium recorded with program code for controlling a computer to process information in which it is possible to move an application easily and safely.

The above objects of the present invention are achieved by an information processor including: a control information retrieving part for retrieving control information that is used to execute a program; a destination defining part for defining destination address information to move the program; a moving part for moving the program in accordance with the destination address information; and a control information changing part for changing the control information based on the destination address information.

According to the present invention, it is possible to move a program as it is, without any changes of optional settings, in accordance with the destination address information. In addition, the present invention does not require a user to change the control information and also the program performs properly so that the user can use the program soon after the program is moved.

The above objects of the present invention are achieved by a method for processing information including the steps of: (a) retrieving control information that is used to execute a program; (b) defining destination address information; (c) moving the program in accordance with the destination address information; and (d) changing the control information based on the destination address information.

According to the present invention, a method is provided to move a program as it is, without any changes of optional settings, in accordance with the destination address information. By applying the method, a user does not have to change the control information and also the program performs properly so that the user can use the program soon after the program is moved.

The above objects of the present invention are achieved by a computer-readable recording medium recorded with program code for controlling a computer to process information, the program code including the codes for: (a) retrieving control information that is used to execute a program; (b) defining destination address information; (c) moving the program in accordance with the destination address information; and (d) changing the control information based on the destination address information.

According to the present invention, a computer-readable recording medium recorded with program code for controlling a computer to process information is provided to move a program as it is, without any changes of options, in accordance with the destination address information. Therefore, a user does not have to change the control information and also the program performs properly so that the user can use the program soon after the program is moved.

### BRIEF DESCRIPTION OF THE DRAWINGS

Other objects, features and advantages of the present invention will become more apparent from the following detailed description when read in conjunction with the accompanying drawings, in which:

FIG. 1 shows an example of a setup window for a conventional installation;

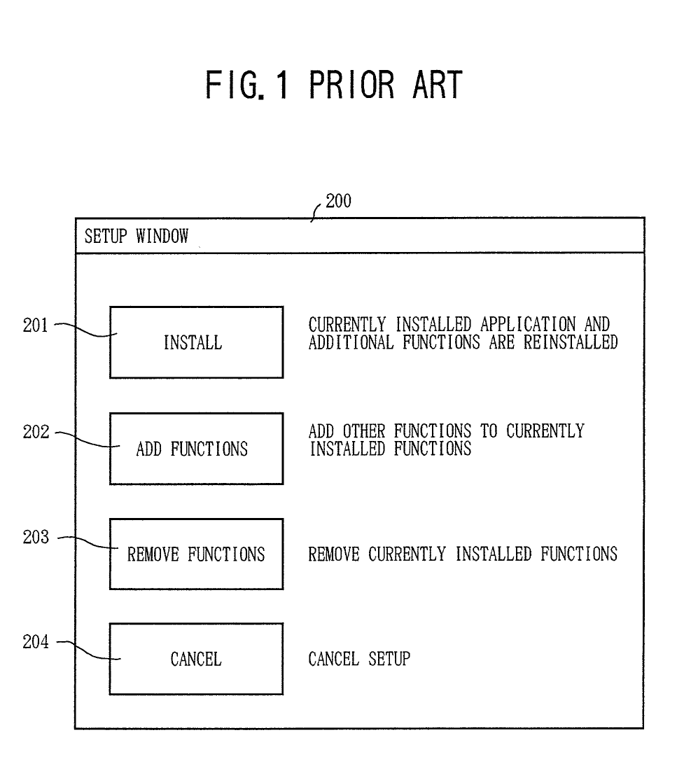

FIG. 2 shows a diagram illustrating an example of a constitution of a whole system according to an embodiment of the present invention;

FIG. 3 shows a diagram illustrating a hardware construction according to the embodiment of the present invention;

FIG. 4A shows a diagram illustrating registry information before an application is moved and FIG. 4B shows a diagram illustrating the registry information after the application is moved;

FIG. 5A shows a diagram illustrating a structure of a definition file according to the embodiment of the present invention and FIG. 5B shows a diagram illustrating an example of the definition file according to the embodiment of the present invention;

FIG. 6 shows a diagram illustrating a setup window according to the embodiment of the present invention;

FIG. 7 shows a diagram illustrating a destination entry window according to the embodiment of the present invention;

FIG. 8 shows a diagram illustrating a dialog box showing a status of the moving application process; and

FIG. 9 shows a flowchart diagram illustrating the moving application process according to the embodiment of the present invention.

### DESCRIPTION OF THE PREFERRED EMBODIMENTS

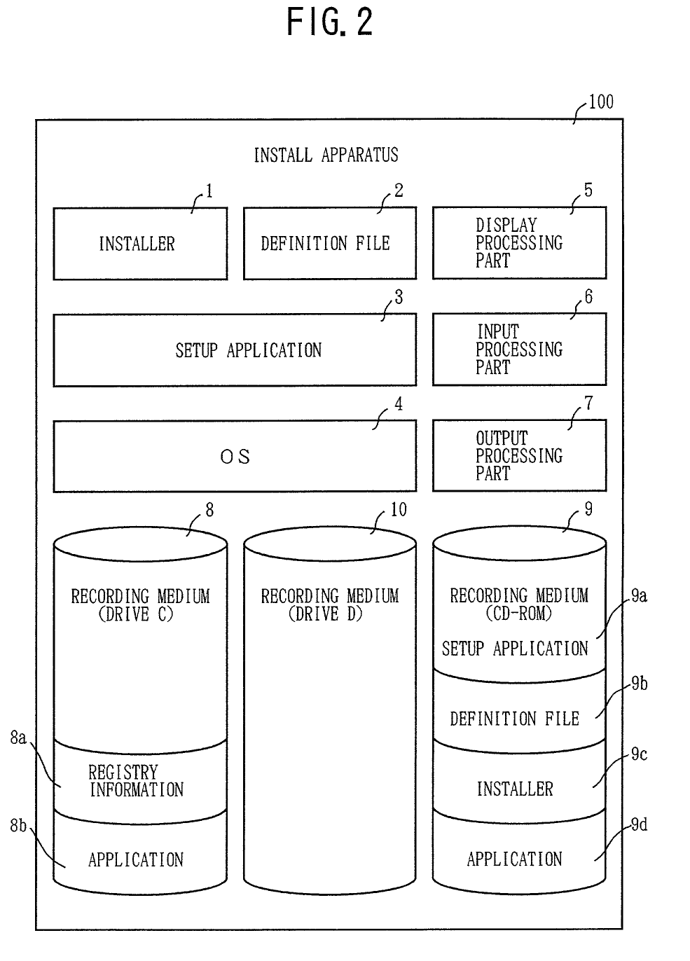

FIG. 2 shows a diagram illustrating an example of a constitution of a whole system according to an embodiment of the present invention.

An install apparatus 100 according to the embodiment corresponds to the information processor and includes the following parts: an installer 1 that is developed in a virtual storage to install an application; a definition file 2 to store destination information; a setup application 3 to setup; an OS 4; a display processing part 5 that controls display information; an input processing part 6 that controls data inputted by a user; an output processing part 7; a recording medium 8 that is internally mounted as a standard drive C; a recording medium 9 such a CD-ROM in which an application is recorded and is sold as a product; and a recording medium 10 which is an external or an internal hard disk such as a drive D that is used as a destination drive when the application is moved. In addition, the recording medium 8 further includes a registry information 8a to maintain all information of installed applications, and an application 8b that performs on the OS 4. The recording medium 9 further includes setup application 9a, a definition file 9b that is developed in the virtual storage to maintain destination information during an installation, an installer 9c that is developed in the virtual storage to control the installation, and an application 9d to be installed into a PC.

It should be noted that the application 8b stored in the recording medium 8 is all or a part of the application 9d recorded in the recording medium 9.

For instance, the install apparatus 100 is required to execute the setup application 9a each time the application 8b installed in the recording medium 8 is moved to the recording medium 10. After the setup application 9a is executed, the setup application 9a, the definition file 9b, and installer 9c are developed in a virtual storage area controlled by the OS 4. In FIG. 2, the installer 1, the definition file 2, and the setup application 3 are the installer 9c, the definition file 9b, and the setup application 9a developed in the virtual storage area, respectively.

The setup application 3 retrieves a current storage address of the installed application from the registry information 8a in the recording medium 8. Subsequently, the setup application 3 retrieves the destination address from the definition file 2 and then executes the installer 1 to move the application 8b in the recording medium 8 to the destination.

The destination information inputted by the user is temporarily maintained in the definition file 2.

When the setup application 3 is terminated, the setup application 3, the installer 1, and definition file 2 are removed from the virtual storage area.

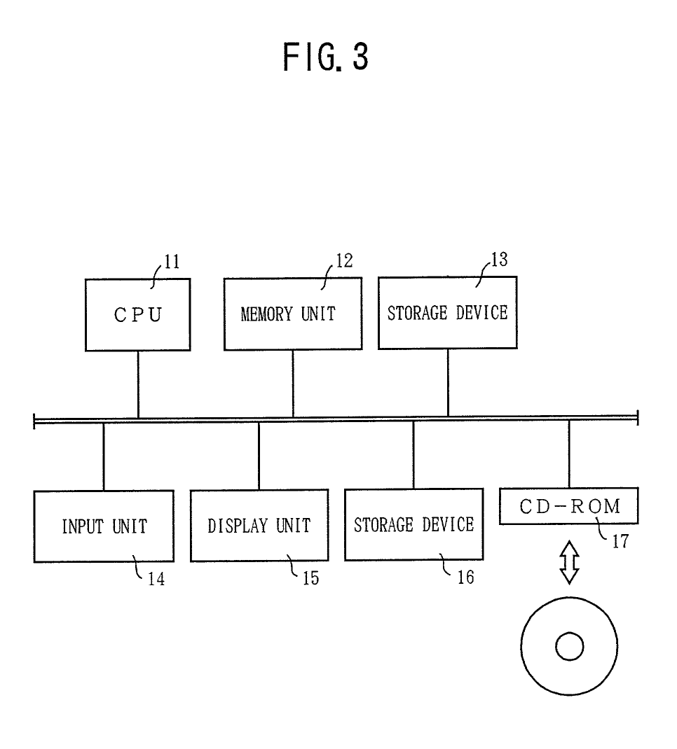

FIG. 3 shows a diagram illustrating a hardware construction according to the embodiment of the present invention.

Referring to FIG. 3, the install apparatus 100 is constructed with the following: a CPU 11 that executes an installation program according to the present invention (explained later); a memory unit 12 that temporarily stores instructions to execute the program and data; a storage device 13 such as a hard disk assigned to a drive C into which the program is loaded and the needed data is stored; an input unit 14 that controls data inputted by a user, a display unit 15 that controls the display information; a storage device 16 such a hard disk assigned to a drive D; and a CD-ROM 17 where the program is recorded. Of course, the medium recording the installation program according to the present invention is not limited to the CD-ROM, but other computer-readable recording media may be used.

The registry information will now be explained.

In this embodiment, the word ‘folder’ is used synonymously with ‘directory’.

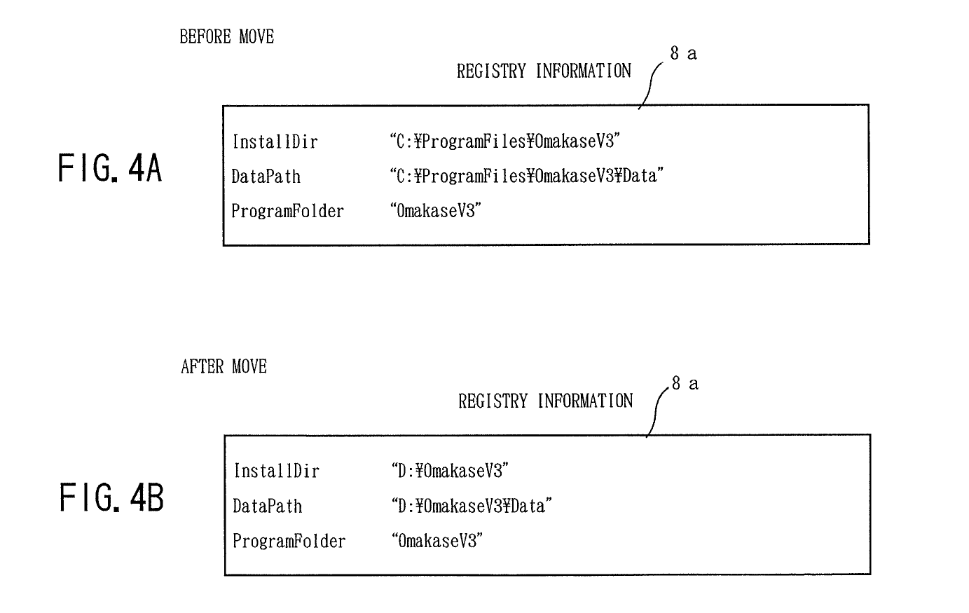

FIG. 4A shows a diagram illustrating the registry information before the application is moved.

It is assumed that a name of the application 8b is “Omakase V3” and the recording medium 8 is assigned to the drive C.

In this example, the registry information 8a includes three keys: InstallDir, DataPath, and ProgramFolder. The key “InstallDir” indicates an area storing the application 8b. That is, a directory “C:¥ProgramFiles¥OmakaseV3”, in which the application “Omakase V3” is installed, corresponds to the key “InstallDir”.

The key “DataPath” indicates a directory “C:¥ProgramFiles¥OmakaseV3¥Data” that stores data needed to perform the application 8b.

The key “ProgramFolder” indicates an area storing a group folder “OmakaseV3” that helps a user to execute the application “Omakase V3” without knowing where the “Omakase V3” is located in the recording medium 8.

FIG. 4B shows a diagram illustrating the registry information after the application is moved.

After the application 8b is moved from the recording medium 8 to the recording medium 10, the registry information 8a is changed by the installer It is assumed that the recording medium 10 is assigned to the drive D.

When the application 8b is moved to the directory “OmakaseV3” in the drive D, the installer 1 changes information such that a directory “D:¥OmakaseV3” corresponds to the key “InstallDir”, a directory “D:¥OmakaseV3¥Data” corresponds to the key “DataPath”, and a group folder “OmakaseV3” corresponds to the key “ProgramFolder”.

The definition file used when the registry information 8a is changed will now be explained.

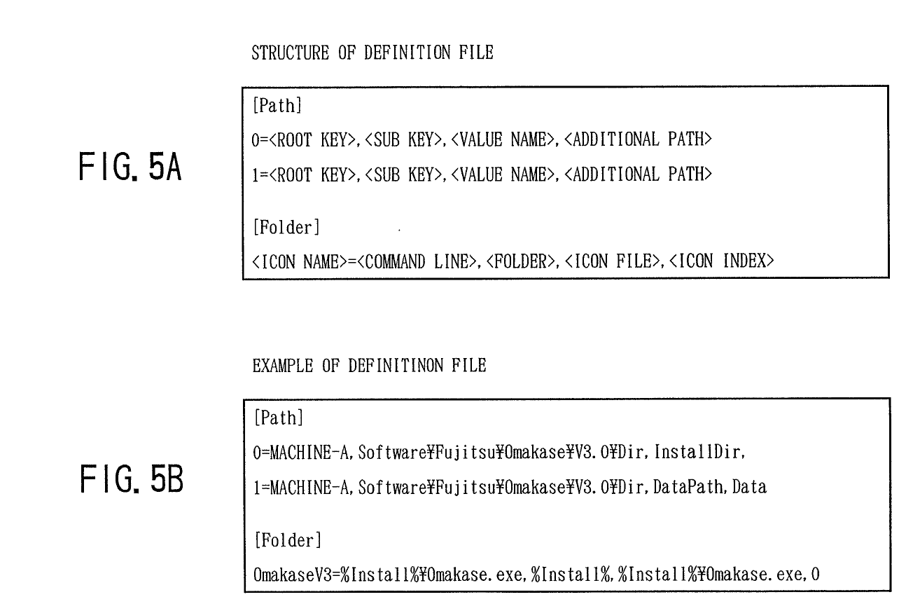

FIG. 5A shows a diagram illustrating a structure of the definition file according to the embodiment of the present invention.

In FIG. 5A, each path information corresponds to each directory information in the registry information 8a as shown in FIG. 4. That is, path 0 and path 1 in FIG. 5A correspond to the keys “InstallDir” and “DataPath” in FIG. 4, respectively.

Each path information is composed of a root key, a subkey, a value name and an additional, path.

The root key and the subkey indicate an address storing the registry information 8a.

The value name indicates the key name defined in the registry information 8a. Thus, the value name indicates information identically in the registry information 8a.

If necessary, the additional path is set with an additional character string composed of the root key and the subkey.

A folder information is composed of the following: an icon name, a command line, a folder, icon file, and an icon index. The folder information is used to change icon data, which is defined for a program folder or for a short cut, to indicate a destination path.

The command line is information to change a work folder or link destination information for the icon data.

The folder is information to change address information.

The icon file is information to change destination information of a program execution file.

The icon index is an icon number to indicate one of a plurality of icons. The icon number starts from 0 indicating the first icon.

FIG. 5B shows a diagram illustrating an example of the definition file according to the embodiment of the present invention.

The path 0 indicates an address storing the registry information 8a by the root key and the subkey. That is, “MACHIN-A¥Software¥Fujitsu¥Omakase¥V3.0¥Dir” indicates the address of the registry information 8a. The value name “InstallDir” corresponds to the key “InstallDir” in FIG. 4B, and indicates an install path as an address of the installed application. The install path is defined by the installer 1.

In the same manner as for the path 0, the root key and the subkey in the path 1 indicate the address of the registry information 8a. The value name “DataPath” corresponds to the key “DataPath” in FIG. 4B. Subsequently, the additional path “Data” is added to the install path so that a data path is defined.

In the folder information in the definition file 2, a variable “Install” is used to set a drive name or a directory name indicated by the user to move the application. In the definition file 2, the variable “Install” is defined between two % characters so as to be recognized as a variable.

In this embodiment, the icon name is defined as “Omakase V3” which is the application name.

The command line is defined by the variable “Install” and an execution file name “Omakase.exe”.

The folder is defined by the variable “Install” which indicates the destination to which to move the application.

The icon file name is defined by the variable “Install” and the execution file name “Omakase.exe”.

The icon index indicates an icon 0. For example, when there are n icons, an icon number starts from 0 and ends at n−1.

It should be noted that contents, a structure and so on of the registry information in the embodiment are well known as that of MS-Windows™ of Microsoft Corporation. This registry information includes many kinds of information to operate hardware and software and is stored as a database file. For example, the registry information of MS-Windows™ is managed by two files: USER.DAT and SYSTEM.DAT.

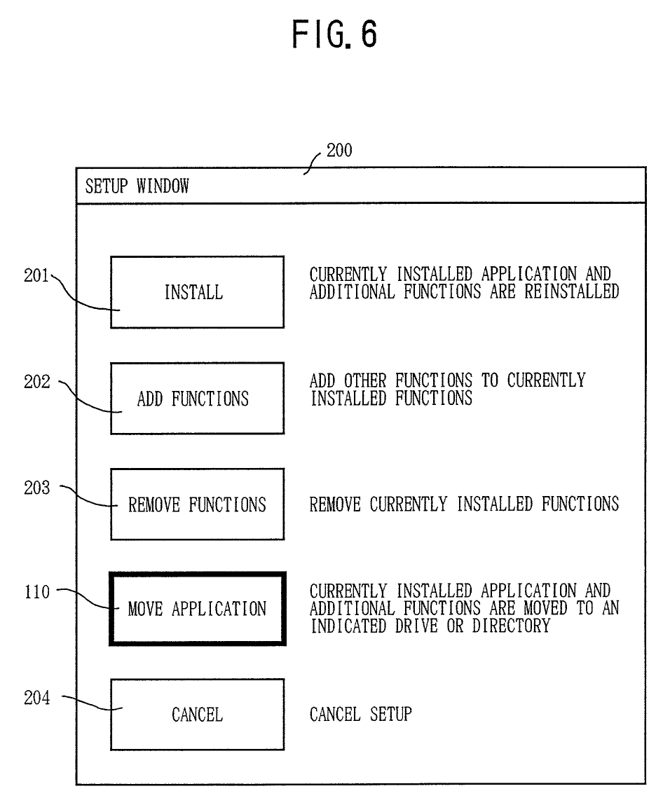

FIG. 6 shows a diagram illustrating a setup window according to the embodiment of the present invention. In this figure, parts that are the same as those shown in the previously described figures are given the same reference numbers.

Referring to FIG. 6, in the setup window 200 according to the embodiment, a “MOVE APPLICATION” button 101 is added.

The “MOVE APPLICATION” button 101 is clicked to move the installed application with additional functions as it is to a drive or a directory indicated by a user.

This function of the “MOVE APPLICATION” does not require the user to store and restore data, and also does not require the user to install additional functions, either.

When the user clicks the “MOVE APPLICATION” button 101 in the setup window 200, a window to indicate a destination is displayed.

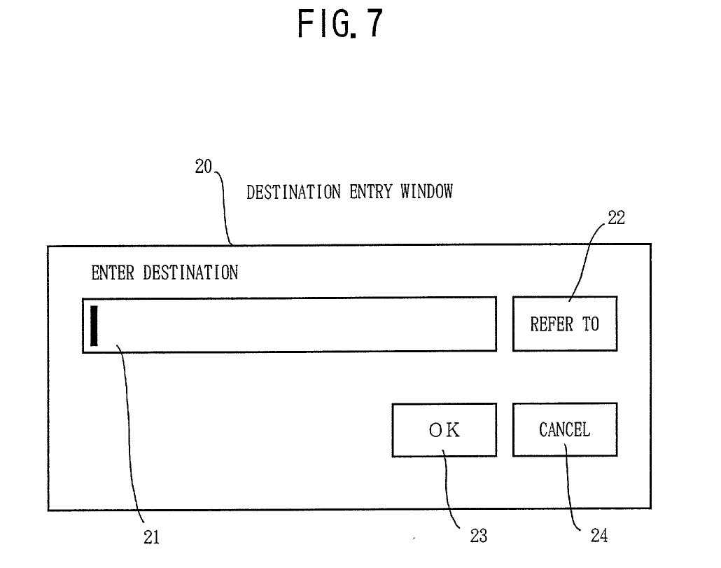

FIG. 7 shows a diagram illustrating a destination entry window according to the embodiment of the present invention.

Referring to FIG. 7, a destination entry window 20 includes a destination input area 21 to input a destination path by a user, a “REFER TO” button 22 to refer to current drives or directories, an “OK” button 23 to move the application, and a “CANCEL” button 24 to cancel the move of the application.

For example, when the user desires to move an application to the drive D to which the recording medium 10 is assigned, the user indicates the drive D in the destination input area 21. When the user does not indicate any directory, a directory “OmakaseV3”, which is the same as the current directory, is created automatically in the drive D.

To indicate a destination, the user inputs a destination path directly in the destination input area 21, or the user clicks the “REFER TO” button 22 and selects from a window showing a list of current drives and directories that appear by clicking the “REFER TO” button 22.

When the user clicks the “OK” button 23 after the user decides and inputs the destination path in the destination input area 21, the installer 1 is executed and the installer 1 proceeds to a moving application process, which will be explained later.

However, when the user terminates the setup process, the user clicks the “CANCEL” button 24.

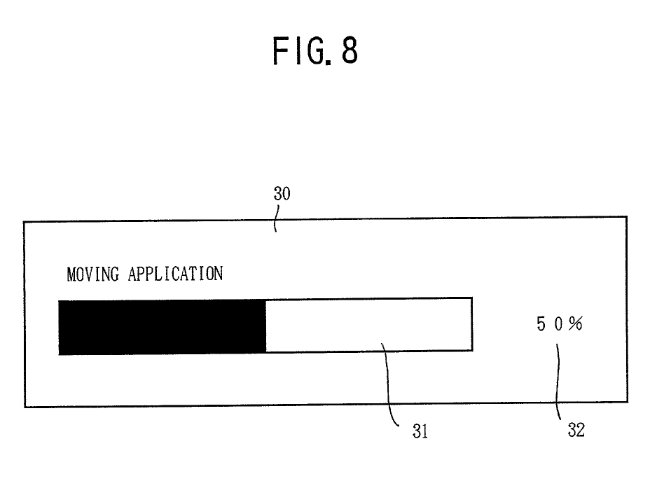

FIG. 8 shows a diagram illustrating a dialog box showing a status of the moving application process.

Referring to FIG. 8, a dialog box 30 includes a barometer 31 that shows a progress of the moving application process visually and a % display 32 that shows a percentage of accomplishment.

When the user clicks the “OK” button 23, the moving application process starts and the dialog box 30 is displayed simultaneously.

In the barometer 31, a dark color part extends to the right side in correspondence with the progress of the moving application process. When the dark color part reaches the end of the right side, it means that the moving application process is completed.

The % display 32 synchronizes with the barometer 31 and shows the progress of the moving application process by a percentage.

The user can visually realize a status of the moving application process.

The moving application process will now be explained. The moving application process is performed by the install program according to the present invention.

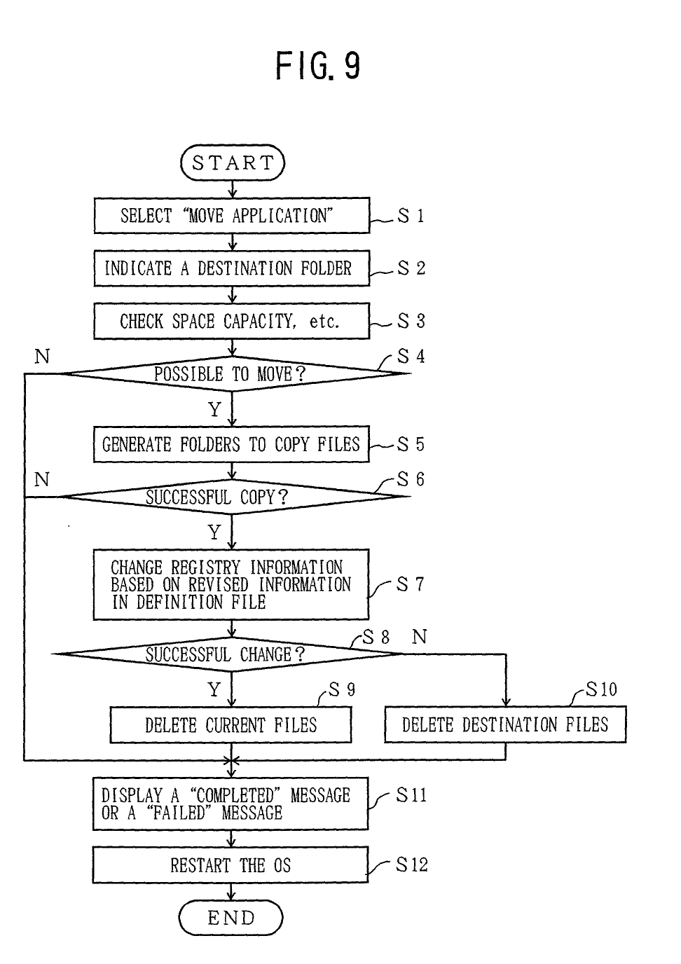

FIG. 9 shows a flowchart diagram illustrating the moving application process according to the embodiment of the present invention.

Referring to FIG. 9, the moving application process includes the following steps: a step S1 to choose the “MOVE APPLICATION” button 110; a step S2 to indicate a destination folder; a step S3 to check a space capacity; a step S4 to check possibility to move; a step S5 to generate folders to copy files; a step S6 to check success in copying; a step S7 to change the registry information; a step S8 to check success in changing; a step S9 to delete original files; a step S10 to delete copied files; a step S11 to display a “COMPLETED” message or “FAILED” message; and a step S12 to restart the OS.

In the step S1, a user clicks the “MOVE APPLICATION” button 110 in the setup window 200 as shown in FIG. 6, and then the moving application process starts.

In the step S2, the destination entry window 20 is displayed so that the user inputs a destination path.

When the user clicks the “OK” button 23 in FIG. 7, a space capacity of the indicated destination disk is checked in the step S3.

In the step S4, when the space capacity is enough to move the application, the step S5 is performed. However, when the space capacity is not enough to move the application, the step S11 is performed in order to display the “FAILED” message to the user.

When the space capacity is recognized as enough, new folders are created in the destination directory in the step S5. Then, the moving application process starts to copy existing files in current folders to the created folders.

The installer 1 refers to the root key and the subkey in the definition file 2 and retrieves the current install path and the current data path from the registry information 8a. That is, the installer 1 retrieves the current install path in accordance with the key “InstallDir” from the registry information 8a and then copies the application from the current install path to the destination. Subsequently, the installer 1 also retrieves the current data path in accordance with the key “DataPath” from the registry information 8a and then copies the data related to the application from the current data path to the destination.

In the step S6, it is checked as to whether copying in the step S5 succeeds or not. When the result is successful, the step S7 is performed to change current paths to new paths in the registry information 8a. When the result is negative, the step S11 is performed to terminate the process.

When copying succeeds in the step S5, the installer 1 sets the destination information indicated by the user to the variable “Install” of the folder information in the definition file 2 and then changes information in the registry information 8a. For example, it is assumed that the user indicates the recording medium 10 assigned to the drive D as the destination to move the application. That is, the user inputs “D:¥OmakaseV3” in the destination input area 21 as shown in FIG. 7. Then, the variable “Install” is replaced with “D:¥OmakaseV3”. The install path indicated by the key “InstallDir” in the registry information 8a is replaced with “D:¥OmakaseV3” and the data path indicated by the key “DataPath” in the registry information 8a is replaced with “D:¥OmakaseV3¥Data” which is a character string composed of the install path and the additional path “Data”.

After the path information in the registry information 8a is changed, it is checked as to whether the replacement with new information in the registry information 8a is completed successfully in the step S8. When the result of the checking is successful, the step S9 is performed to delete the application stored in the current directory. When the result is negative, the step S11 is performed to display the “FAILED” message.

After completing the change of the path information, the original files, including the application 8b in the current directory in the recording medium 8 assigned to the drive C, are deleted in the step S9.

When in replacing with new path information in the registry information 8a fails, the created files, including the copied application 8b in the recording medium 10 assigned to the drive D, are deleted in the step S10.

In the step S11, in accordance with a status of decision steps S4, S6, and S8, a “COMPLETED” message or a “FAILED” message is displayed to notify the user of the result of the process.

After displaying a message, the process restarts the OS 4 and then the process is terminated in the step S12.

As mentioned above, all of the installed applications, the installed additional functions, and created data are copied to the destination indicated by the user as it is so that the user does not need to reinstall the same additional functions and does not set again optional settings of the application to fit the user's requirements such as a font size, lines per page, and the like. In addition, a use is only required to indicate a destination so that the user does not have to uninstall the application from the current directory, install the application in a new directory, and restart the OS several times. Therefore, the present invention can reduce time consumption and perform effectively to move an application.

In this embodiment, in a case in which two recording media are assigned to two logical drives C and D, respectively, the manner of moving an application (a program) is explained. Alternately, the present invention can be applied to a case in which one recording medium is segmented into two areas and is assigned to two logical drives C and D, respectively, so that an application is moved within one and the same recording medium.

Further, the present invention can be applied to another case in which a destination directory is defined as a current directory in the same logical drive, so that an application is moved within the same logical drive. In the embodiment, an application is physically moved to another directory in another recording medium. On the contrary, in the case in which an application is moved within the same logical drive, instead of copying, it is possible to move a current application by changing management information such directory information and file information, which are managed by a file management system of the OS. It should be noted that the present invention is related to not only a manner of moving an application (a program) physically to another recording medium but also to a manner of changing the management information of the file management system without copying the application.

In addition, when an application is installed again, information showing the fact that the application is installed is saved in an install information part that is referred to when the application is deleted by the OS. It should be noted that this technology is well known as that of MS-Windows™ The present invention is not limited to the specifically disclosed embodiments, variations and modifications, and other variations and modifications may be made without departing from the scope of the present invention.

The present application is based on Japanese Priority Application NO. 11-054179 filed on Mar. 2, 1999, the entire contents of which are hereby incorporated by reference.

What is claimed is:

1. An information processor comprising:
a control information retrieving part retrieving control information that is used to execute a program;
a destination defining part defining destination address information;
a moving part moving the program in accordance with the destination address information; and
a control information changing part changing the control information based on the destination address information.

2. The information processor as claimed in claim 1, wherein said control information comprises current address information indicating where the program is stored in a storage device, and
wherein said control information changing part comprises a replacing part replacing the current address information with the destination address information to which the program is moved.

3. The information processor as claimed in claim 1, wherein said control information is generated when said program is installed into a storage device.

4. The information processor as claimed in claim 1, wherein said control information is referred to when said program is executed.

5. The information processor as claimed in claim 1, wherein said control information is stored in a file referred to by other programs, and the file includes a plurality of control information to execute the other programs.

6. The information processor as claimed in claim 1, wherein said control information comprises definition information including at least one destination address information related to the program and including at least one definition name uniquely assigned to the destination address information, and
wherein said control information changing part comprises a changing part changing said control information based on said definition information.

7. The information processor as claimed in claim 1, wherein said control information comprises:
current address information indicating where the program is stored in a storage device;
definition information including at least one destination address information related to the program and including at least one definition name uniquely assigned to the destination address information,
wherein said moving part comprises:
a copying part retrieving the current address information corresponding to said definition name included in said control information in accordance with said definition information and copying all information, which is stored at a current address indicated by the current address information, in accordance with the destination address information; and
a deleting part deleting all information stored at the current address, and
wherein said control information changing part comprises:
a changing part changing the current address information included in said control information based on the destination address information included in said definition information.

8. The information processor as claimed in claim 1, wherein said control information comprises:
program information to execute the program; and
data information related to data created or edited by executing said program, and
wherein said moving part comprises:
a program moving part moving the program; and
a data moving part moving the data when the program is moved by said program moving part.

9. The information processor as claimed in claim 1, further comprising an installing part installing said program.

10. A method for processing information comprising the steps of:
(a) retrieving control information that is used to execute a program;
(b) defining destination address information;
(c) moving the program in accordance with the destination address information; and
(d) changing the control information based on the destination address information.

11. The method as claimed in claim 10, wherein said control information includes current address information indicating where the program is stored in a storage device, and
wherein said step (d) comprises the step of replacing the current address information with the destination address information to which the program is moved.

12. The method as claimed in claim 10, wherein said control information is generated when said program is installed into a storage device.

13. The method as claimed in claim 10, wherein said control information is referred to when said program is executed.

14. The method as claimed in claim 10, wherein said control information is stored in a file referred to by other programs, and the file includes a plurality of control information to execute the other programs.

15. The method as claimed in claim 10, wherein said control information comprises definition information including at least one destination address information related to the program and including at least one definition name uniquely assigned to the destination address information, and
wherein said step (d) comprises the step of changing said control information based on said definition information.

16. The method as claimed in claim 10, wherein said control information comprises:
current address information indicating where the program is stored in a storage device;
definition information including at least one destination address information related to the program and including at least one definition name uniquely assigned to the destination address information,
wherein said step (c) comprises the steps of:
retrieving the current address information corresponding to said definition name included in said control information in accordance with said definition information
copying all information, which is stored at a current address indicated by the current address information, in accordance with the destination address information; and
deleting all information stored at the current address, and
wherein said step (d) comprises the steps of:
changing the current address information included in said control information based on the destination address information included in said definition information.

17. The method as claimed in claim 10, wherein said control information comprises program information to execute the program and data information related to data created or edited by executing said program, and
wherein said step (c) comprises the steps of:
moving the program; and
moving the data when the program is moved.

18. The method as claimed in claim 10, further comprising the step of installing said program.

19. A computer-readable recording medium recorded with a program code for causing a computer to process information, said program code comprising the codes for:
(a) retrieving control information that is used to execute a program;
(b) defining destination address information;
(c) moving the program in accordance with the destination address information; and
(d) changing the control information based on the destination address information.

20. The computer-readable recording medium as claimed in claim 19, wherein said control information includes current address information indicating where the program is stored in a storage device, and
wherein said code (d) comprises code for replacing the current address information with the destination address information to which the program is moved.

21. The computer-readable recording medium as claimed in claim 19, wherein said control information is generated when said program is installed into a storage device.

22. The computer-readable recording medium as claimed in claim 19, wherein said control information is referred to when said program is executed.

23. The computer-readable recording medium as claimed in claim 19, wherein said control information is stored in a file referred to by other programs and the file includes a plurality of control information to execute the other programs.

24. The computer-readable recording medium as claimed in claim 19, wherein said control information comprises definition information including at least one destination address information related to the program and including at least one definition name uniquely assigned to the destination address information, and
wherein said code (d) comprises the code for changing said control information based on said definition information.

25. The computer-readable recording medium as claimed in claim 19, wherein said control information comprises:
current address information indicating where the program is stored in a storage device;
definition information including at least one destination address information related to the program and including at least one definition name uniquely assigned to the destination address information,
wherein said code (c) comprises the codes for:
retrieving the current address information corresponding to said definition name included in said control information in accordance with said definition information
copying all information, which is stored at a current address indicated by the current address information, in accordance with the destination address information; and
deleting all information stored at the current address, and
wherein said code (d) comprises the code for:
changing the current address information included in said control information based on the destination address information included in said definition information.

26. The computer-readable recording medium as claimed in claim 19, wherein said control information comprises program information to execute the program and data information related to data created or edited by executing said program, and
wherein said code (c) comprises the codes for:
moving the program; and
moving the data when the program is moved.

27. The computer-readable recording medium as claimed in claim 19, further comprising the code for installing said program.
